(19) United States
(12) Patent Application Publication
(10) Pub. No.: US 2011/0249729 A1
(43) Pub. Date: Oct. 13, 2011

(54) ERROR RESILIENT HIERARCHICAL LONG TERM REFERENCE FRAMES

(75) Inventors: Xiaosong ZHOU, Campbell, CA (US); Dazhong Zhang, Milpitas, CA (US); Davide Concion, San Jose, CA (US); Hsi-Jung Wu, San Jose, CA (US); Douglas Scott Price, San Jose, CA (US)

(73) Assignee: Apple Inc., Cupertino, CA (US)

(21) Appl. No.: 12/794,580

(22) Filed: Jun. 4, 2010

Related U.S. Application Data
(60) Provisional application No. 61/321,811, filed on Apr. 7, 2010.

(51) Int. Cl. H04N 7/26

(52) U.S. Cl. 375/240.07; 375/240.16; 375/E07.126

(57) ABSTRACT

Embodiments of the present invention provide a video encoding system that codes video sequence into a multi-level hierarchy based on levels of long term reference (LTR) frames. According to the present invention, an encoder designates a reference frame as a long term reference (LTR) frame and transmits the LTR frame to a receiver. Upon receiving feedback from the receiver acknowledging receipt of the LTR frame, the encoder periodically codes subsequent frames as reference frames using the acknowledged LTR frame as a reference and designates subsequent reference frames as secondary LTR frames. A determined number of frames after each secondary LTR frame may be coded using a preceding secondary LTR frame as a reference.

### CROSS REFERENCE TO RELATED APPLICATIONS

The present application claims the benefit of US Provisional application, Ser. No. 61/321,811, filed Apr. 7, 2010, entitled “ERROR RESILIENT HIERARCHICAL LONG TERM REFERENCE FRAMES,” the disclosure of which is incorporated herein by reference in its entirety.

### FIELD OF THE INVENTION

The present invention is directed to video processing techniques and devices. In particular, the present invention is directed to a video encoding system that builds a hierarchy of long term reference frames and adjusts the hierarchy adaptively.

### BACKGROUND

In a video coding system, such as that illustrated in FIG. 1, an encoder 110 compresses video data before sending it to a receiver such as a decoder 120. One common technique of compression uses predictive coding techniques (e.g., temporal/motion predictive encoding). That is, some frames in a video stream are coded independently (I-frames) and some other frames (e.g., P-frames or B-frames) are coded using other frames as reference frames. B-frames are coded with reference to a previous frame (P-frame) and B-frames are coded with reference to previous and subsequent frame (Bi-directional).

The resulting compressed sequence (bitstream) is transmitted to a decoder 120 via a channel 130, which can be a transmission medium or a storage device such as an electrical, magnetic or optical storage medium. To recover the video data, the bitstream is decompressed at the decoder 120, which inverts coding processes performed by the encoder and yields a decoded video sequence.

The compressed video data may be transmitted in packets when transmitted over a network. The communication conditions of the network may cause packets of one or more frames to be lost. Lost packets can cause visible errors and the errors can propagate to subsequent frames if the subsequent frames depend on the frames that have packet loss. One solution is for the encoder/decoder to keep the reference frames in a buffer and start using another reference frame (e.g., an earlier reference frame) if a packet loss for the current reference frame is detected. However, due to constraints in buffer sizes, the encoder/decoder is not able to save all the reference frames in the buffer. For error resilience purposes, the encoder can mark certain frames in the bit stream and signal the decoder to store these frames in the buffer until the encoder signals to discard them. They are called long term reference (LTR) frames.

For example, as shown in FIG. 1, the encoder 110 transmits to the decoder 120 a stream of frames. The stream of frames includes a LTR frame 1001 and subsequent frames 1002-1009. Each subsequent frame is coded using the preceding frame as a reference. For example, the frame 1002 is coded using the LTR frame 1001, the frame 1003 is coded using the frame 1002, and the frame 1009 is coded using the frame 1008, etc. Once the transmission of the frames starts, the sender (e.g., encoder 110) can request an acknowledgement from the receiver (e.g., decoder 120) indicating whether the long term reference frame (e.g., LTR 1001) is correctly received and reconstructed by the decoder. When the decoder 120 detects a packet loss in one of the subsequent frames, the decoder 120 informs the encoder 110 and requests a subsequent frame to be encoded using an acknowledged long term reference frame as a reference, in order to stop error propagation caused by the detected loss. For example, assume the LTR frame 1001 is the latest acknowledged LTR frame by the decoder 120, if the decoder 120 detects a packet loss for the frame 1005, the decoder 120 can send a request to the encoder 110 to encode a subsequent frame (e.g., 1006) using the acknowledged LTR 101 as the reference frame. However, the communication channel between the encoder 110 and decoder 120 may not always have a stable condition. Sometimes, there is a long delay for the encoder 110 to receive such requests. In these conditions, error propagation can last for a long time at the receiver end and it causes poor viewing experience.

Accordingly, there is a need in the art for adjusting the designations of the LTRs adaptively based on channel conditions and quickly stopping the error propagation.

### BRIEF DESCRIPTION OF THE DRAWINGS

FIG. 1 is a conventional encoding system and a stream of coded frames encoded by the conventional encoding system.

FIG. 2(a) is a simplified block diagram of an exemplary encoding system according to an embodiment of the present invention.

FIG. 2(b) is a hierarchy of coded frames encoded by an exemplary encoding system according to an embodiment of the present invention.

FIG. 3 is another hierarchy of coded frames encoded by another exemplary encoding system according to an embodiment of the present invention.

FIG. 4 is a flow diagram of coding a hierarchy of coded frames according to an embodiment of the present invention.

FIG. 5 is an example embodiment of a particular hardware implementation of the present invention.

FIG. 6 is a block diagram of a video coding/decoding system according to an embodiment of the present invention.

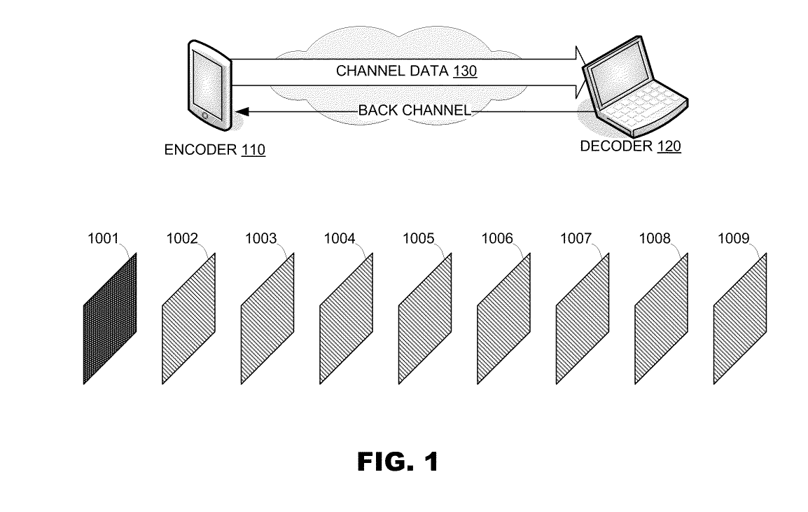

### DETAILED DESCRIPTION

Embodiments of the present invention provide an encoder that may build a hierarchy of coded frames in the bit stream to improve the video quality and viewing experience when transmitting video data in a channel that is subject to transmission errors. The hierarchy may include “long term reference” (LTR) frames and frames coded to depend from the LTR frames. LTR frames may be provided in the channel on a regular basis (e.g., 1 frame in every 10 frames). The hierarchy, including the frequency of the LTR frames, can be adjusted adaptively based on the channel conditions (e.g., the error rate, error pattern and delay), in order to provide effective error protection at reasonably small cost. If a channel error does occur and transmitted frames are lost, use of the LTR frames permits the decoder to recover from the transmission error even before the encoder can be notified of the problem.

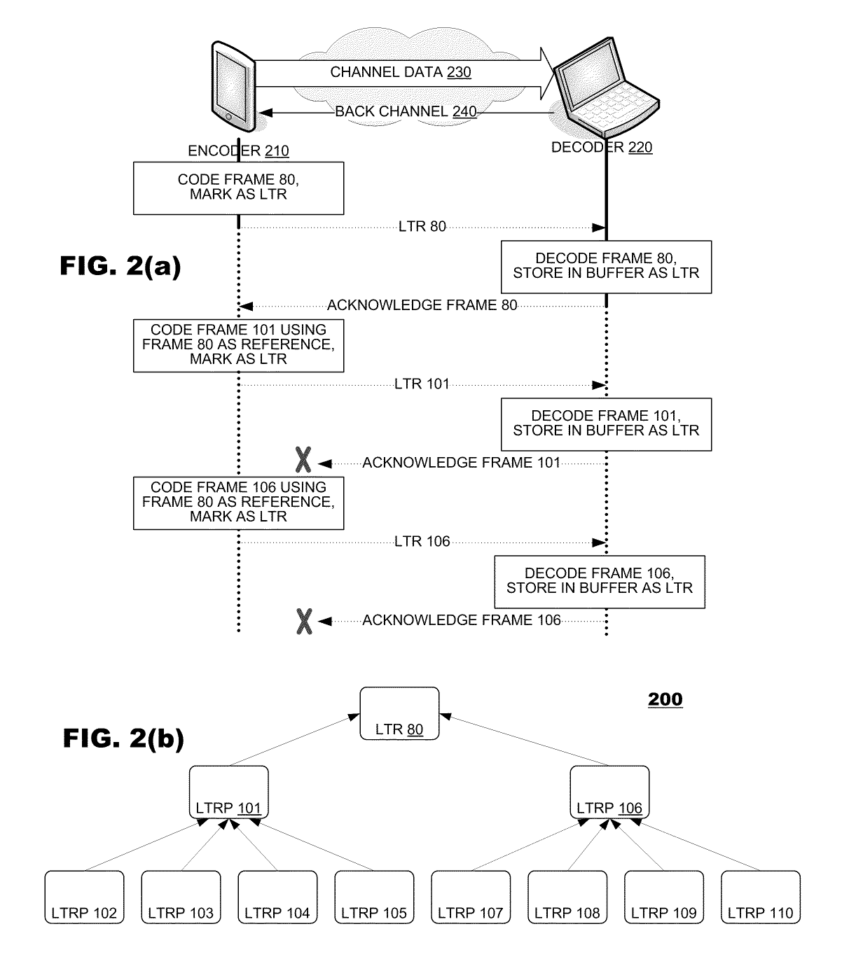

FIG. 2(a) illustrates a simplified block diagram of a video coding/encoding system 200, in which an encoder 210 and decoder 220 are provided in communication via a forward channel 230 and a back channel 240. The encoder 210 may encode video data into a stream of coded frames. The coded frames may be transmitted via the forward channel 230 to the decoder 220, which may decode the coded frames. The coded frames may include LTR frames and frames encoded using LTR frames as prediction references (“LTRP frames”). The coded frames may also include frames that are neither LTR nor LTRP (e.g., frames that are coded using a preceding non-LTR frame as a reference). The decoder 220 may send acknowledgement messages to the encoder 210 via a back channel 240 when LTR frames are received and decoded successfully.

In one embodiment, the encoder 210 may encode source video frames as LTR or LTRP frames at a predetermined rate (e.g., one LTR frame every 10 frames, rest nine frames being LTRP frames encoded using the LTR frame as a reference frame). In a further embodiment, some of the LTRP frames may also be selected to be marked as LTR frames (e.g., secondary LTR frames), and each secondary LTR frames may be encoded with reference to a preceding acknowledged LTR frame. The encoder 210 may encode frames subsequent to a secondary LTR frame using the secondary LTR frame as a reference. The decoder 220 may retain the LTR frame (including the secondary LTR frames) in a buffer until instructed to discard it, decode the subsequently received frames according to each frame's reference frame, and report packet losses. the encoder 210 may periodically send instructions to the decoder 220 to manage the decoder 220's roster of LTR frames, e.g., identifying a specific LTR frame for eviction from the decoder's cache, sending a generic message that causes eviction of all reference frames that occur in coding order prior to a designated frame.

The channels 230, 240 may be provided as respective communication channels in a packet-oriented network. The channel may be provided in a wired communication network (e.g., by fiber optical or electrical physical channels), may be provided in a wireless communication network (e.g., by cellular or satellite communication channels) or by a combination thereof. The channel may be unreliable and packets may be lost. The channel conditions (e.g., the delay time, error rate, error pattern, etc.) may be detected by other service layers (not shown) of the communication network between the encoder 210 and decoder 220.

FIG. 2(a) also illustrates a sequence of events for the communication between the encoder 210 and decoder 220 in communication via the channel. As shown in FIG. 2(a), the encoder 210 may code frame 80, mark it as a LTR, and transmit the coded frame 80 to the decoder 220. Upon receive of frame 80, the decoder 220 may decode the frame 80 and verify that no packets of the frame 80 have been lost. If frame 80 is received without errors, the decoder 220 may send an acknowledgement message to the encoder 210 indicating that the LTR frame 80 is received correctly. Because the frame 80 is marked as LTR by the encoder 210, the decoder 220 may keep it in a buffer until receiving an instruction from the encoder 210 indicating the LTR frame 80 can be discarded.

Upon receipt of the acknowledgement that the LTR frame 80 has been correctly received by the decoder 220, the encoder 210 may encode a subsequent frame 101 using the LTR frame 80 as a reference. Thus, the frame 101 may be a LTRP frame. The encoder 210 may also mark the frame 101 as a LTR frame (e.g., a secondary LTR frame) and transmit it to the decoder 220. Subsequently, the encoder 210 may code a segment of frames using the secondary LTR frame 101 as a reference. The segment may contain a predetermined number of frames, for example, 4 frames.

Thereafter, the encoder 210 may code the next frame (e.g., frame 106) using the LTR frame 80 as a reference. Thus, the frame 106 may be another LTRP frame. And, subsequently, the encoder 210 may code a segment of frames using the LTR frame 106 as a reference. The segment may contain the predetermined number of frames as discussed above, for example, 4 frames.

In one or more embodiments, the decoder 220 may send acknowledgements of successful receipt of subsequent LTR frames (e.g., frames 101, 106) to the encoder 210. If the acknowledgements are received by the encoder 210, the encoder 210 may update its record and start using the most recently acknowledged LTR frame as a reference to code subsequent frames as described above. However, as shown in FIG. 2(a), because the channel may be unreliable and packets may be lost, acknowledgements may be lost (e.g., acknowledgements for the secondary LTR frames 101 and 106 may be lost). Thus, the LTR frame 80 may be the only acknowledged LTR frame so far in the communication.

The secondary LTR frames 101 and 106 may stop error propagation caused by any errors that occurred before their arrival. For example, if frame 101 is received correctly, frame 102, 103, 104 and 105 may be correctly decoded as long as not packet loss occurs for either one of these frames. Thus, secondary LTR frames 101 and 106 may stop any error propagation due to packet losses prior to their arrival.

FIG. 2(b) illustrates a stream of coded frames encoded according to a three-level hierarchy 200 and to be transmitted from the encoder 210 to the decoder 220. In one or more embodiments, the encoder 210 may adjust the levels of hierarchy and/or span of number of frames (e.g., adjusting the predetermined number to change the frequency of secondary LTR frames) in a segment according to the channel conditions (e.g., the delay time, error rate, error pattern, etc.). The three-level hierarchy 200 may include a top-tier LTR frame 80. The top-tier LTR frame 80 may be an acknowledged LTR frame (e.g., acknowledgement received by the encoder 210 as shown in FIG. 2(a)). The three-level hierarchy 200 may further include a plurality of secondary LTR frames (e.g., frames 101 and 106) coded using the top-tier LTR frame as a reference. Moreover, The three-level hierarchy 200 may include a third-tier of predetermined number of LTRP frames subsequent to each secondary LTR frame coded using the preceding secondary LTR frame. For example, LTRP frames 102, 103, 104 and 105 are coded using LTR frame 101 as a reference, and LTRP frames 107, 108, 109 and 110 are coded using LTR frame 106 as a reference.

In one or more embodiments, the predetermined number (e.g., frequency of the LTR frames) may be adjusted as needed. For example, if it is nine (9), then there will be a secondary LTR frame based on an acknowledged LTR frame every 10 frames; if it is fourteen (14), then there will be a secondary LTR frame based on an acknowledged LTR frame every 15 frames. The predetermined number may determine the span of frames without a LTR frame and this may be adjusted based on the channel conditions.

As described with respect to FIG. 2(a) above, the secondary frames 101 and 106 may stop error propagation caused by any errors that occur before their arrival. For example, if frame 101 is received correctly, frame 102, 103, 104 and 105 can be correctly decoded and stop any error propagation prior to frame 101's arrival.

In one embodiment, after an acknowledgement is received for a secondary LTR frame, the acknowledged secondary LTR frame may be designated as a new top-tier LTR frame for subsequent coding. The above hierarchy may be repeated based on the new top-tier LTR frame. Further, the encoder (e.g., encoder 210) may send an instruction to the decoder (e.g., decoder 220) to clear all LTR frames in the decoder's buffer received prior to the new top-tier LTR frame. Alternatively, the encoder does not need to send such instruction to flush all LTR frames prior to the new top-tier LTR frame. As long as the buffer is big enough, keeping multiple top-tier LTR frames gives the option of choosing one that may give best quality when time is allowed.

As shown in FIG. 2(b) and discussed above with respect to FIG. 2(a), an embodiment according to the present invention may encode the frames according to a hierarchy 200 of LTR frames. The hierarchy 200 may have a top-tier LTR frame 80. In one embodiment, the top-tier LTR 80 is an acknowledged LTR frame successfully received and decoded at a receiver (e.g., decoder 220). Underneath the top-tier LTR frame, there may be a plurality of secondary LTR frames (e.g., frames 101 and 106) coded using the top-tier LTR frame as a reference. At the leave level, segments of frames may be coded using the secondary LTR frames as reference.

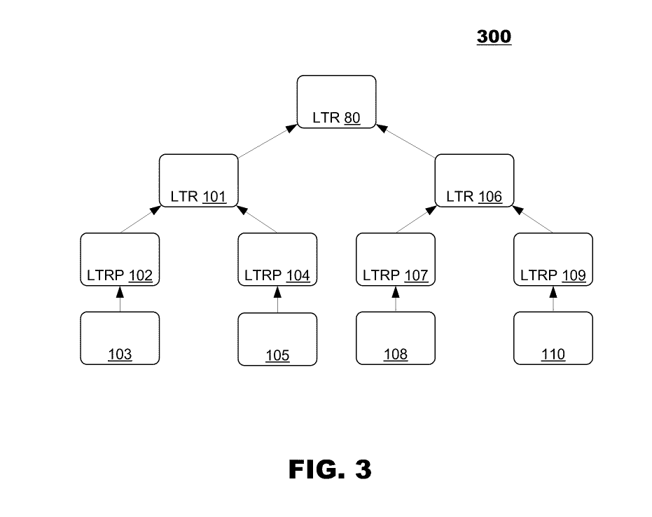

FIG. 3 illustrates an exemplary four-level LTR hierarchy 300 according to another embodiment of the present invention. As shown in FIG. 3, them 4-level hierarchy 300 may have a top-tier LTR frame 80. The top-tier LTR frame 80 may be an acknowledged LTR frame. At the second-tier level, a plurality of secondary LTR frames (e.g., frames 101 and 106) may be coded using the top-tier LTR frame as a reference. Then at the third-tier level, periodically, a predetermined number of subsequent frames after each secondary LTR frame are to be coded using the preceding secondary LTR frame. The fourth-tier level (e.g., leave level) may be frames that are coded using a preceding frame as a reference.

For the example shown in FIG. 3, the period at the third-tier level may be two (e.g., every other frame) and the predetermined number may also be two. For example, after the secondary LTR frame 101, two LTRP frames 102 and 104 are coded using LTR 101 as a reference, and LTRP frames 107 and 108 are coded using LTR 106 as a reference.

In one embodiment, the period may be a different number other than 2. For example, the period may be every one in three frames, so underneath each secondary LTR frame, there will be one LTRP frame at the third level and two frames at the fourth level. In this configuration, the 1^{st},4^{th} frames after a secondary LTR frame may be coded as LTRP frames using the preceding secondary LTR frame as a reference, the 2^{nd} frame may be coded using the 1^{st} frame as a reference and 3^{rd} frame may be coded using the 2^{nd} frame as a reference; and the errors occurring in any frames after the secondary LTR frame will propagate from one frame to next until the next LTRP frame.

In another embodiment, the predetermined number can also be a different number other than 2. For example, if it is three (3), then there may be three LTRP frames underneath each secondary LTR frame. In those embodiments described above, the predetermined number may determine the span of frames without a LTR frame, and this may be adjusted based on the channel conditions.

At the fourth level, the frames are coded using a preceding frame as a reference, thus, frames of fourth-tier level are not be LTRP frames. For example, frames 103, 105, 108 and 110 are coded using LTRP frames 102, 104, 107 and 109 as references respectively. Although the hierarchy 300 shows three tiers of LTR frames, in one or more embodiments, an encoder according to the present invention may encode the video data in more tires according to the channel conditions.

Adjustment of the Hierarchy According to Channel Conditions

In an embodiment of the present invention, the number of hierarchy levels, the number and distribution of frames in each hierarchy level, may be adjusted according to channel conditions, including the delay time, error rate, error pattern, etc, in order to achieve different trade off between error resilience capability and frame quality. For example, with respect to the four level hierarchy 300 described above, the number of frames contained at the fourth level may be increased or decreased based on channel conditions. Further, the frequency of the LTR frames may be adjusted (e.g., one LTR frame in every 5 frames, or one in every 10 frames). In addition, levels of LTR frames may also be adjusted (e.g., in addition to top-tier and second-tier as described above, more tiers of LTR frames may be added when needed).

In another embodiment, the distance between two secondary LTR frames may be kept shorter than the channel round trip delay time, in order to achieve a faster recover during packet loss than the “refresh frame request” mechanism, in which case the receiver requests a refresh frame upon packet loss, and the encoder sends a refresh frame (an instantaneous decoding refresh (IDR) for example) to stop the error propagation after getting the request.

Stopping Error Propagation

In both of the hierarchies 200 and 300 shown in FIGS. 2(b) and 3, as described above, the LTR frames 101 and 106 can stop error propagation caused by any errors that occurred before their arrival. In FIG. 2(b), for example, if frame 101 is received correctly, frames 102, 103, 104 and 105 can be correctly decoded and stop any error propagation prior to frame 101's arrival. Further, because each of the frames 102, 103, 104 and 105 is coded using the frame 101 as reference, errors caused by packet loss in any of the frames will not propagate to the next frame. In FIG. 3, for example, if frame 101 is correctly received, frames 102 and 104 can be correctly decoded and stop any error propagation prior to their arrival. Frame 103 is coded using the LTRP frame 102, so error in frame 102 may propagate to frame 103, and any errors in frame 104 may propagate to frame 105. Thus, hierarchy 200 may provide a better protection than hierarchy 300.

Hierarchy 200 may have more overhead (more cost for coding, transmission and/or decoding) than hierarchy 300. In hierarchy 200, for example, each of frames 102, 103, 104 and 105 may be coded with reference to the LTR frame 101. For frames 103, 104 and 105, they are further away from the reference frame 101, and thus, may need more bits to code. In hierarchy 300, however, frames 103 and 105 are coded using an immediately preceding frame as a reference frame, thus, may not need a lot of bits to code.

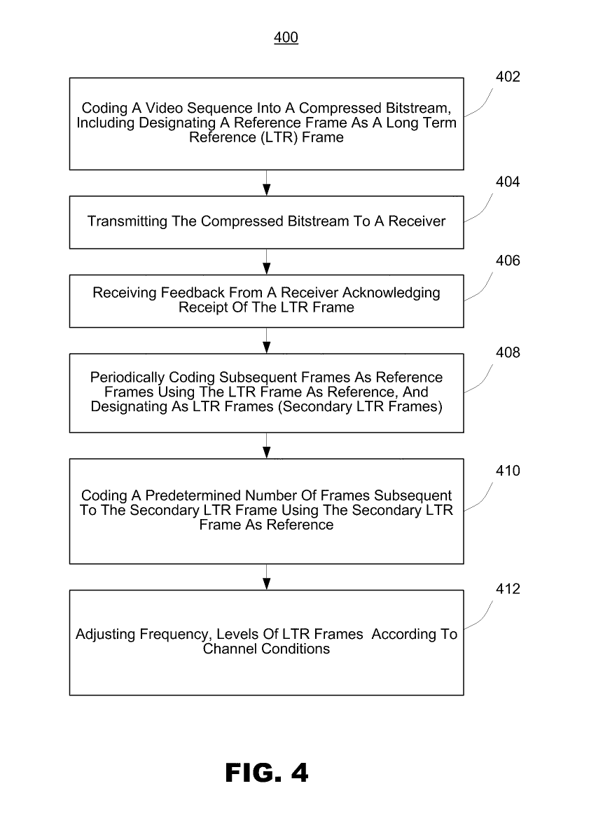

FIG. 4 illustrates a method 400 according to the present invention. At step 402, an encoder may code a video sequence into a compressed bitstream. The coding may include designating a reference frame as a long term reference (LTR) frame. At step 404 the encoder may transmit the compressed bitstream to a receiver (e.g., a decoder). At step 406 the encoder may receive feedback from a receiver acknowledging receipt of the LTR frame. At step 408, the encoder may periodically code subsequent frames as reference frames and designate these reference frames as LTR frames. These LTR frames may be referred to as secondary LTR frames. At step 410, the encoder may periodically code a predetermined number of frames subsequent to the secondary LTR frame using the secondary LTR frame as reference. In one embodiment, some frames subsequent to secondary LTR frames may be coded using a preceding non-LTR frame as a reference and referred to as non-LTRP frames. At step 412, the encoder may adjust frequency, levels of LTR frames according to channel conditions.

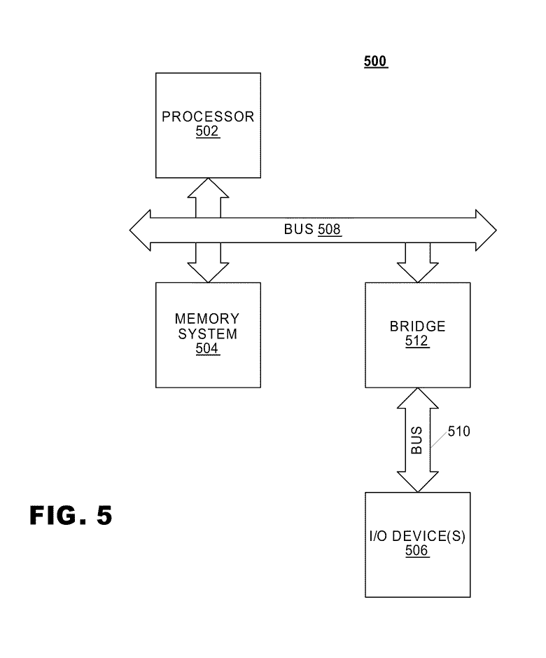

FIG. 5 is a simplified functional block diagram of a computer system 500. A coder and decoder of the present invention can be implemented in hardware, software or some combination thereof. The coder and or decoder may be encoded on a computer readable medium, which may be read by the computer system of 500. For example, an encoder and/or decoder of the present invention can be implemented using a computer system.

As shown in FIG. 5, the computer system 500 includes a processor 502, a memory system 504 and one or more input/output (I/O) devices 506 in communication by a communication ‘fabric.’ The communication fabric can be implemented in a variety of ways and may include one or more computer buses 508, 510 and/or bridge devices 512 as shown in FIG. 5. The I/O devices 506 can include network adapters and/or mass storage devices from which the computer system 500 can receive compressed video data for decoding by the processor 502 when the computer system 500 operates as a decoder. Alternatively, the computer system 500 can receive source video data for encoding by the processor 502 when the computer system 500 operates as a coder.

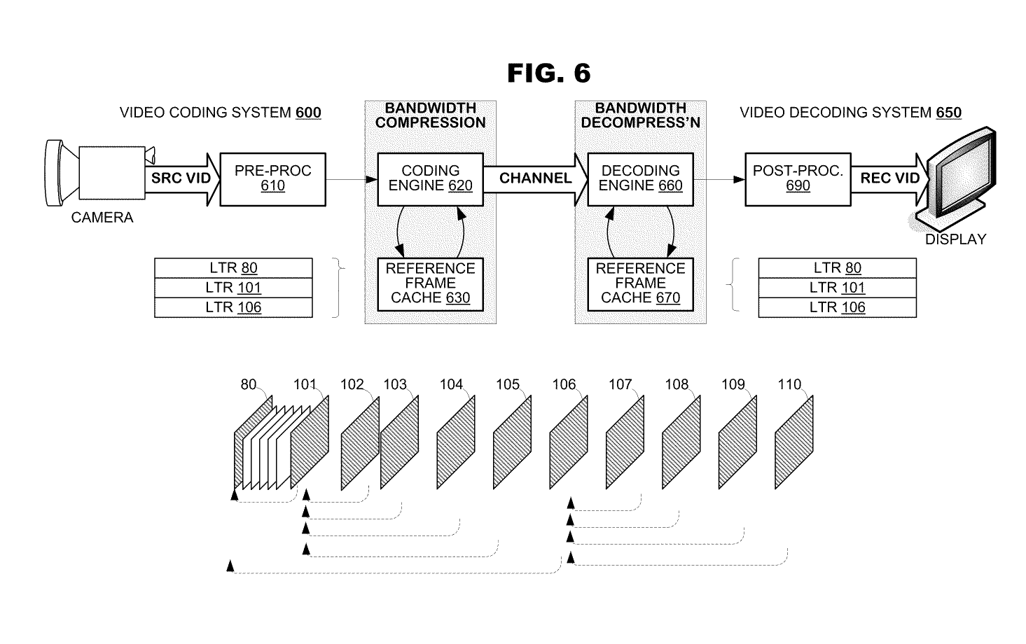

FIG. 6 illustrates a video coding system 600, a video decoding system 650 and a stream of coded frames according to an embodiment of the present invention. The video coding system 600 may include a pre-processor 610, a coding engine 620 and a reference frame cache 630. The pre-processor 610 may perform processing operations on frames of a source video sequence to condition the frames for coding. The coding engine 620 may code the video data according to a predetermined coding protocol. The coding engine 620 may output coded data representing coded frames, as well as data representing coding modes and parameters selected for coding the frames, to a channel. The reference frame cache 630 may store decoded data of reference frames previously coded by the coding engine; the frame data stored in the reference frame cache 630 may represent sources of prediction for later-received frames input to the video coding system 600.

The video decoding system 650 may include a decoding engine 660, a reference frame cache 670 and a post-processor 690. The decoding engine 660 may parse coded video data received from the encoder and perform decoding operations that recover a replica of the source video sequence. The reference frame cache 670 may store decoded data of reference frames previously decoded by the decoding engine 660, which may be used as prediction references for other frames to be recovered from later-received coded video data. The post-processor 690 may condition the recovered video data for rendering on a display device.

The stream of coded frames may be a stream representing the hierarchy 200 shown in FIG. 2(b) transmitted from the video coding system 600 to the video decoding system 650. The arrows underneath the frames may indicate the dependencies from preceding reference frames. For example, the LTR frames 101 and 106 may depend from acknowledged LTR frame 80, frames 102-105 may depend from LTR frame 101 and frames 107-110 may depend from LTR frame 106. It should be noted that although the dependency of the frames may be illustrated as the hierarchies 200 or 300, the frames may be coded/transmitted/decoded in a stream. In one embodiment, there may be B-frames among the non-reference frames coded using the LTR reference frames as reference frames.

During operation, the coding engine 620 may select dynamically coding parameters for video, such as selection of reference frames, computation of motion vectors and selection of quantization parameters, which are transmitted to the decoding engine 660 as part of channel data; selection of coding parameters may be performed by a coding controller (not shown). Similarly, selection of pre-processing operation(s) to be performed on the source video may change dynamically in response to changes in the source video. Such selection of pre-processing operations may also be administered by the coding controller.

As noted, in the video coding system 600, the reference frame cache 630 may store decoded video data of a predetermined number n of reference frames (for example, n=16). The reference frames may have been previously coded by the coding engine 620 then decoded and stored in the reference frame cache 630. Many coding operations are lossy processes, which cause decoded frames to be imperfect replicas of the source frames that they represent. By storing decoded reference frames in the reference frame cache, the video coding system 600 may store recovered video as it will be obtained by the decoding engine 660 when the channel data is decoded; for this purpose, the coding engine 620 may include a video decoder (not shown) to generate recovered video data from coded reference frame data. As illustrated in FIG. 6, for example, the reference frame cache 630 may store the reference frames according to the hierarchy of FIG. 2(b), in which frames 80, 101 and 104 may be stored as long term reference frames.

In the video decoding system 650, the reference frame cache 670 may store decoded video data of frames identified in the channel data as reference frames. For example, FIG. 6 shows the reference frame cache 670 may store reference frames according to the hierarchy of FIG. 2(b), in which frames 80, 101 and 104 may be stored as long term reference frames. During operation, the decoding engine 660 may retrieve data from the reference frame cache 670 according to motion vectors provided in the channel data, to develop predicted pixel block data for used in pixel block reconstruction. According to an embodiment of the present invention, a decoding controller (not shown) may decode each received frame according to an identifier provided in the channel data to apply a previously received reference frame as indicated by the identifier. Accordingly, the predicted pixel block data used by a decoding engine 660 should be identical to predicted pixel block data as used by the coding engine 610 during video coding.

The post-processor 690 may perform additional video processing to condition the recovered video data for rendering, commonly at a display device. Typical post-processing operations may include applying deblocking filters, edge detection filters, ringing filters and the like. The post-processor 690 may output recovered video sequence that may be rendered on a display device or stored to memory for later retrieval and display.

As discussed above, the foregoing embodiments provide a coding/decoding system that build a hierarchy of coded frames in the bit stream to protect the bit stream against transmission errors. The techniques described above find application in both software- and hardware-based coders. In a software-based coder, the functional units may be implemented on a computer system (commonly, a server, personal computer or mobile computing platform) executing program instructions corresponding to the functional blocks and methods described in the foregoing figures. The program instructions themselves may be stored in a storage device, such as an electrical, optical or magnetic storage medium, and executed by a processor of the computer system. In a hardware-based coder, the functional blocks illustrated hereinabove may be provided in dedicated functional units of processing hardware, for example, digital signal processors, application specific integrated circuits, field programmable logic arrays and the like. The processing hardware may include state machines that perform the methods described in the foregoing discussion. The principles of the present invention also find application in hybrid systems of mixed hardware and software designs.

In an embodiment, the channel may be a wired communication channel as may be provided by a communication network or computer network. Alternatively, the communication channel may be a wireless communication channel exchanged by, for example, satellite communication or a cellular communication network. Still further, the channel may be embodied as a storage medium including, for example, magnetic, optical or electrical storage devices.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

We claim:

1. A video encoding system, comprising:
an encoder to code an input video sequence into a compressed bitstream, the coding including:
responsive to receiving feedback from the receiver acknowledging receipt of a LTR frame:
periodically coding subsequent frames as reference frames using the acknowledged LTR frame as a reference,
designating the subsequent reference frames as secondary LTR frames, and
coding a predetermined number of frames after each secondary LTR frame using a preceding secondary LTR frame as a reference.

2. The system of claim 1, wherein the acknowledged LTR frame forms a top-tier of a multi-level hierarchy and the periodically designated secondary LTR frames forms a second-tier of the multi-level hierarchy.

3. The system of claim 2, wherein the hierarchy has three levels, the predetermined number of frames after each secondary LTR frame forms the third-tier, and the predetermined number is equal to the number of frames between two adjacent designated secondary LTR frames.

4. The system of claim 2, wherein the hierarchy has more than three levels with the predetermined number of frames coded using the preceding secondary LTR frame as a reference forming the third-tier, and the encoder encodes at least one fourth-tier frame after each frame in the third-tier and uses that frame in the third-tier as a reference.

5. The system of claim 2, wherein the coding further includes adjusting the hierarchy based on channel conditions.

6. The system of claim 5, wherein the channel conditions include error rate.

7. The system of claim 5, wherein the channel conditions include error pattern.

8. The system of claim 5, wherein the channel conditions include delay.

9. The system of claim 5, wherein adjusting the hierarchy includes adjusting frequency of the secondary LTR frames.

10. The system of claim 5, wherein adjusting the hierarchy includes adjusting levels of the multi-level hierarchy.

11. The system of claim 5, wherein adjusting the hierarchy includes both of adjusting frequency of the secondary LTR frames and adjusting levels of the multi-level hierarchy.

12. The system of claim 2, wherein the coding further includes:
receiving another feedback from the receiver acknowledging receipt of a subsequent LTR frame, and
coding subsequent frames into the multi-level hierarchy using the subsequently acknowledged LTR frame as the top-tier LTR frame.

13. The system of claim 12, wherein the encoder sends an instruction to the decoder to clear all LTR frames in the decoder's buffer prior to the acknowledged subsequent LTR frame.

14. A method of coding video data, comprising:
responsive to receiving feedback from a receiver acknowledging receipt of a LTR frame:
periodically coding subsequent frames as reference frames using the acknowledged LTR frame as a reference,
designating the subsequent reference frames as secondary LTR frames, and
coding a predetermined number of frames after each secondary LTR frame using a preceding secondary LTR frame as a reference.

15. The method of claim 14, wherein the acknowledged LTR frame forms a top-tier of a multi-level hierarchy and the periodically designated secondary LTR frames forms a second-tier of the multi-level hierarchy.

16. The method of claim 15, further comprising adjusting the hierarchy based on channel conditions.

17. The method of claim 15, further comprising:
receiving another feedback from the receiver acknowledging receipt of a subsequent LTR frame, and
coding subsequent frames into the multi-level hierarchy using the subsequently acknowledged LTR frame as the top-tier LTR frame.

18. The method of claim 17, wherein the encoder sends an instruction to the decoder to clear all LTR frames in the decoder's buffer prior to the acknowledged subsequent LTR frame.

19. A method of coding video data, comprising:
coding frames into a multi-level reference hierarchy using an acknowledged LTR frame as a top-tier reference, including:
periodically coding select frames as reference frames using the top-tier reference as a reference frame,
designating the coded reference frames as LTR frames and using these LTR frames as second-tier reference;
coding a plurality of frames at a third-tier of the hierarchy using respective preceding second-tier reference frames as reference frames.

20. The method of claim 19, wherein the hierarchy is adjusted based on channel conditions.

21. The method of claim 20, wherein the channel conditions include error rate.

22. The method of claim 20, wherein the channel conditions include error pattern

23. The method of claim 20, wherein the channel conditions include delay.

24. The method of claim 20, wherein adjusting the hierarchy includes adjusting frequency of the LTR frames.

25. The method of claim 20, wherein adjusting the hierarchy includes adjusting levels of the multi-level hierarchy.

26. A video decoder comprising:
a reference frame cache to store decoded frame data of previously-decoded reference frames,
a decoding engine operable to decode input channel data according to motion compensated prediction techniques with reference to a reference frame, wherein the input channel data contains a multi-level reference hierarchy with a stored and acknowledged LTR frame as a top-tier reference, the decoding engine is to periodically decode and store reference frames that use the top-tier reference as a reference frame.

27. The video decoder of claim 26, wherein the hierarchy is adjusted based on channel conditions.

28. The video decoder of claim 26, wherein adjusting the hierarchy includes adjusting frequency of the LTR frames.

29. A channel carrying a coded video data signal generated according to a process of:
coding frames into a multi-level reference hierarchy using an acknowledged LTR frame as a top-tier reference, including:
periodically coding select frames as reference frames using the top-tier reference as a reference frame,
designating the coded reference frames as LTR frames and using these LTR frames as second-tier reference;
coding a plurality of frames at a third-tier of the hierarchy using respective preceding second-tier reference frames as reference frames.

30. The channel of claim 29, wherein the hierarchy is adjusted based on channel conditions.

31. The channel of claim 29, wherein adjusting the hierarchy includes adjusting frequency of the LTR frames.
